(19) United States
(12) Patent Application Publication
(10) Pub. No.: US 2023/0416557 A1
(43) Pub. Date: Dec. 28, 2023

(54) ANTIFOG COMPOSITIONS AND ARTICLES MADE THEREOF

(71) Applicant: Kraton Corporation, Houston, TX (US)

(72) Inventors: Bharadwaja Peddinti, Houston, TX (US); Felipe Niada, Houston, TX (US); Roger Tocchetto, Houston, TX (US)

(73) Assignee: Kraton Corporation, Houston, TX (US)

(21) Appl. No.: 18/462,695

(22) Filed: Sep. 7, 2023

Related U.S. Application Data
(63) Continuation-in-part of application No. 17/301,935, filed on Apr. 19, 2021.
Application No. 17/301,935 is a continuation-in-part of application No. 17/995,762, filed on Oct. 7, 2022.
(60) Provisional application No. 63/374,775, filed on Sep. 7, 2022.
(60) Provisional application No. 62/704,479, filed on May 12, 2020.
(60) Provisional application No. 63/011,576, filed on Apr. 17, 2020.
(60) Provisional application No. 63/019,634, filed on May 4, 2020.
(60) Provisional application No. 63/052,914, filed on Jul. 16, 2020.
(60) Provisional application No. 63/200,298, filed on Feb. 28, 2021.

(51) Int. Cl. C09D 153/02; C09D 5/16; C09D 7/20; C08F 297/04; C08J 7/04; C08J 7/056

(52) U.S. Cl. CPC C09D 153/025; C09D 5/1668; C09D 7/20; C08F 297/04; C08J 7/0427; C08J 7/056; C08F 2810/00; C08J 2367/02; C08J 2453/02

(57) ABSTRACT

The disclosure relates to an article comprising a substrate and an antifog coating layer provided on at least one surface of the substrate. The antifog coating layer comprises a sulfonated styrenic block copolymer (SSBC) having a block A, a block B, and a block D. Block A is a polymer block resistant to sulfonation and derived from a para-substituted styrene monomer, block B is a polymer block susceptible to sulfonation and derived from a vinyl aromatic monomer, and block D is a polymer block resistant to sulfonation and derived from a conjugated diene monomer. The antifog coating layer provides long-term antifog as well as anti-microbial protection properties. The selection of a specific solvent system can modify the SSBC film morphology leading to enhanced antifog property. The antifog coating layer adheres well to targeted substrates and has abrasion resistance property.

### RELATED APPLICATIONS

This application claims benefit to U.S. Provisional Application No. 63/374,775, filed on Sep. 7, 2022, incorporated herein by reference. This application is a continuation-in-part of U.S. patent application Ser. No. 17/301,935 with a filing date of Apr. 19, 2021, and U.S. patent application Ser. No. 17/995,762, filed on Oct. 7, 2022, both are hereby incorporated herein by reference.

### FIELD

The disclosure relates to antifog coating compositions, methods of preparation and articles made therefrom.

### BACKGROUND

Optically transparent articles such as goggles, helmets, vehicle windows, windshields, etc., can become hazy or blurred when covered with fog. Fog formation typically occurs under conditions of high humidity and/or high temperature, or at interfacial boundaries where there is a significant difference between temperature and humidity. Antifog coatings are designed to minimize the likelihood of fog formation on the surface of these articles. Various surfactants and hydrophilic compounds have been utilized in the development of antifog coatings.

Some swimming goggles are equipped with an antifog coating, which can develop mold or fungi if the goggles are not properly maintained. However, this coating can be easily eliminated by washing the goggles with soap. In other applications requiring antifog properties, such as medical environments, maintaining a clean goggle surface is imperative. In a study conducted in December 2021 at the COVID-19 isolation ward in Wuhan, China, medical goggles that were pre-treated with antibacterial hand sanitizer demonstrate the ability to prevent fogging for up to 4 hours. Nevertheless, the antifogging effect of the hand sanitizer was temporary, necessitating frequent reapplication for a prolonged effect.

There is a need to provide enduring antifog protection for articles, along with additional benefits of long-term residual protection from microbes.

### SUMMARY

In one aspect, the disclosure relates to an article comprising, consisting essentially of, or consisting of a substrate and an antifog coating layer provided on at least one surface of the substrate. The antifog coating layer comprises a sulfonated styrenic block copolymer (SSBC) having at least one block A, at least one block B, and at least one block D. Block A is a polymer block resistant to sulfonation and selected from polymerized: (i) para-substituted styrene monomers, (ii) ethylene, (iii) alpha olefins of 3 to 18 carbon atoms, (iv) 1,3-cyclodiene monomers, (v) monomers of conjugated dienes having a vinyl content less than 35 mole % prior to hydrogenation, (vi) acrylic esters, (vii) methacrylic esters, and (viii) mixtures thereof. Block B is a polymer block susceptible to sulfonation and derived from a vinyl aromatic monomer and the block B has a degree of sulfonation of >10 mole %. Block D is a polymer block resistant to sulfonation and derived from a conjugated diene monomer. The antifog coating layer is characterized as having a T_{fog} of greater than 8 seconds, measured according to ASTM F659, and a yellowness index (ΔYI) of less than 4, measured according to ASTM E313. The sulfonated styrenic block copolymer in the antifog coating layer has a morphology consisting of at least 50% interconnected channels.

In a second aspect, the sulfonated styrenic block copolymer in the antifog coating layer has a morphology selected from the group consisting of cylindrical, lamellar, double diamond, gyroid, spheres, and mixtures thereof.

In a third aspect, the antifog coating layer is obtained by mixing the sulfonated styrenic block copolymer in a solvent system to obtain a mixture having a concentration of 5 to 30 wt. % of the SSBC in the solvent system and depositing the mixture on the substrate.

In a fourth aspect, the sulfonated styrenic block copolymer in the antifog coating layer has a morphology consisting of at least 50% interconnected channels of block B, provided the solvent system comprises at least 50 wt. % of a polar solvent.

In a fifth aspect, a method for increasing a T_{fog} of an antifog coating layer is provided. The method comprises: (a) providing a sulfonated styrenic block copolymer, (b) selecting a solvent system to form interconnected channels in the layer of at least >50%, (c) mixing the sulfonated styrenic block copolymer into the solvent system to obtain a mixture, and (d) forming an antifog coating layer by depositing the mixture onto a substrate.

In a sixth aspect, a method for increasing a T_{fog} of an antifog coating layer is provided. The method comprises: (a) providing a sulfonated styrenic block copolymer, (b) selecting a solvent system containing a single solvent to form >50% of a lamellar morphology or a cylindrical morphology in the layer, (c) mixing the sulfonated styrenic block copolymer into the solvent system to obtain a mixture, and (d) forming an antifog coating layer by depositing the mixture onto a substrate.

In a seventh aspect, another method for increasing a T_{fog} of an antifog coating layer is provided. The method comprises: (a) providing a sulfonated styrenic block copolymer, (b) selecting a solvent system containing at least a polar solvent and at least a nonpolar solvent in a weight ratio of 1:3-3:1 to form >50% of a lamellar morphology or a cylindrical morphology in the layer, (c) mixing the sulfonated styrenic block copolymer into the solvent system to obtain a mixture, and (d) forming an antifog coating layer by depositing the mixture onto a substrate.

In an eighth aspect, a method of modifying the morphology of the SSBC in an antifog coating layer is provided. The method comprises: (a) providing a layer containing the SSBC, (b) selecting a solvent system for the SSBC to form interconnecting channels having a lamellar morphology or a cylindrical morphology, the interconnecting channels constitute at least 50% of the morphology of the layer, and optionally (c) subjecting the antifog coating layer to a solvent annealing step in the presence of the solvent system.

In a ninth aspect, a method of modifying the morphology of the SSBC in the antifog coating layer is provided. The method comprises: (a) providing a layer containing the SSBC, and (b) subjecting layer to a thermal annealing step at a suitable temperature for the SSBC to form interconnecting channels having a lamellar morphology or a cylindrical morphology, the interconnecting channels constitute at least 50% of the morphology of the layer.

### DESCRIPTION

The following terms will be used throughout the specification.

“At least one of [a group such as X, Y, and Z]” or “any of [a group such as X, Y, and Z]” means a single member from the group, more than one member from the group, or a combination of members from the group. For example, at least one of X, Y, and Z includes, for example, X only, Y only, or Z only, as well as X and Y, X and Z, Y and Z; or X, Y, and Z, or any other all combinations of X, Y, and Z.

A list of embodiments presented as “X, Y, or Z” is to be interpreted as including the embodiments, X only, Y only, Z only, “X or Y,” “X or Z,” “Y or Z,” or “X, Y, or Z”.

“Bicontinuous morphology” refers to a structure, or a morphology with two different and distinct (continuous but non-intersection) domains, where at least one of the domains takes a shape of a ribbon, a sheet, a fiber, or a cylinder, providing a network of ionic conductive channels.

“Lamellar morphology” or “bilayer morphology” refers to a phase domain morphology having layers of alternating compositions that generally are oriented parallel with respect to one another. In some embodiments, the domain size is 15-100 nm. The term “lamellar morphology” also includes lamellae. The morphologies can be bicontinuous.

“Cylindrical morphology” “hexagonal morphology” refers to a phase domain morphology having discrete tubular or cylindrical shapes. The tubular or cylindrical shapes can be hexagonally packed on a hexagonal lattice. The domain size can be in the range of 15-100 nm. The morphologies can be bicontinuous.

“Gyroid morphology” refers to a phase domain morphology having a network structure with triply connected junctions. The domain size can be 15-100 nm and the morphologies can be bicontinuous.

“Double diamond morphology” refers to a phase domain morphology having a double-diamond symmetry of space group Pn3m. The domain size can be 15-100 nm and the morphologies can be bicontinuous.

“Solubility Parameter” or (S) of a solvent or polymer, refers to the square root of the vaporization energy (ΔE) divided by its molar volume (V), as in the equation δ=(ΔE/V)^{1/2}. The more similar the solubility parameters of two substances, the higher will be the solubility between them and hence the expression “like dissolves like.” Hansen established that the solubility parameter of a solvent or polymer is the result of the contribution of three types of interactions: dispersion forces (δ_{D}²), polar interactions (δ_{P}²) and hydrogen bonds (δ_{H}²) (Hansen, 2007; Hansen, 1967), with the total solubility (Hildebrand) parameter δT as the result of contribution of each of the three Hansen solubility parameters (HSP) according to: δ_{T}=(δ²_{D}+δ²_{P}+δ²_{H})^{1/2}.

“Antifog” refers to the prevention or inhibition of build-up of condensation on a surface (e.g., lens, window, glass, etc.). Antifog property can be expressed by the value T_{fog}, which is the time it takes to form a fog on a surface, i.e., time without fogging.

“Polystyrene content” or PSC of a block copolymer refers to the weight % of vinyl aromatic, e.g., styrene in the block copolymer, calculated by dividing the sum of molecular weight of all vinyl aromatic units by the total molecular weight of the block copolymer. PSC can be determined using any suitable methodology such as proton nuclear magnetic resonance (NMR).

“Molecular weight” or M_{w} refers to the polystyrene equivalent molecular weight in g/mol of a polymer block or a block copolymer. M_{w} can be measured with gel permeation chromatography (GPC) using polystyrene calibration standards, such as is done according to ASTM 5296. The GPC detector can be an ultraviolet or refractive index detector or a combination thereof. The chromatograph is calibrated using commercially available polystyrene molecular weight standards. M_{w} of polymers measured using GPC so calibrated are polystyrene equivalent molecular weights or apparent molecular weights. M_{w} expressed herein is measured at the peak of the GPC trace and are commonly referred to as polystyrene equivalent “peak molecular weight,” designated as Mₚ.

“Susceptible to sulfonation” refers to a polymer, polymer block, compound, monomer, oligomer, etc., being predisposed, or sensitive, or capable of reaction with sulfur containing compound, e.g., SO₃, H₂SO₄, etc., under conditions conventionally employed for sulfonation, wherein sulfonation is very likely to occur to obtain a sulfonated product. In embodiments, a polymer block “susceptible to sulfonation” upon sulfonation, the degree of sulfonation is at least 10 mol %, or at least 20 mol %, or at least 30 mol %, or at least 50 mol %, or at least 75 mol %, of the total polymer block, for the polymer block to have at least 10 mol %, or at least 20 mol %, or at least 30 mol %, or at least 50 mol %, or at least 75 mol % sulfonic acid or sulfonate ester functional groups.

“Resistant to sulfonation” means having little if any sulfonation of the respective block under conditions conventionally employed for sulfonation, with <10 mol %, or <8 mol %, or <5 mol % sulfonic acid or sulfonate ester functional groups in the polymer block.

“Ion Exchange Capacity” or IEC refers to the total active sites or functional groups responsible for ion exchange in a polymer. Generally, a conventional acid-base titration method is used to determine the IEC, see for example International Journal of Hydrogen Energy, Volume 39, Issue 10, Mar. 26, 2014, Pages 5054-5062, “Determination of the ion exchange capacity of anion-selective membrane.” IEC is the inverse of “equivalent weight” or EW, which is the weight of the polymer required to provide 1 mole of exchangeable protons.

“Haze” refers to the percentage of transmitted light that upon passing through a specimen is scattered greater than 2.5 degrees from the normal. Haze and transmittance can be measured according to ASTM D1003. A higher haze value indicates greater scattering.

“Blushing” refers to a phenomenon where the antifog coating or solution itself forms a hazy or cloudy appearance on the surface after application. This can occur due to factors like improper formulation, residue left behind during application, or interactions with the surface material.

“Blushing suppression effect” refers to additives or formulations that help prevent or reduce hazy or cloudy appearance (blushing) that can occur after application. These additives or formulations could work by promoting even coating, preventing residue buildup, or enhancing the clarity of the treated surface.

The disclosure relates to an article having an antifog coating layer comprising a sulfonated styrenic block copolymer (SSBC). The antifog coating layer provides long-term antifog as well as anti-microbial protection properties. The antifog property can be optimized with the selection of a solvent system to modify the SSBC film morphology, tailoring its water transport capability to prolong the antifog effect. The antifog coating layer also shows excellent adhesion to a substrate, durability, and abrasion resistance properties.

(Sulfonated Styrenic Block Copolymer (SSBC))

The SSBC is obtained by sulfonation of a styrenic block copolymer (SBC) precursor which is any of linear, branched, or radial block copolymer having a block A, a block B, and a block D.

In embodiments, block A comprises polymerized para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof.

In embodiments, block A has at least one compound selected from polymerized (i) para-substituted styrene, (ii) ethylene, (iii) alpha olefins of 3-18 carbon atoms, (iv) 1,3-cyclodiene, (v) conjugated dienes having a vinyl content of <35 mol % prior to hydrogenation, (vi) acrylic esters, (vii) methacrylic esters, and (viii) mixtures thereof. If the block A is a polymer of 1,3-cyclodiene or conjugated diene, the block A will be hydrogenated subsequent to preparation of the SBC precursor. In embodiments, the block A contains up to 15 wt. % of vinyl aromatic monomers such as those present in the block B.

In embodiments, block A has a Mₚ of 1-60, or 2-50, or 5-45, or 8-40, or 10-35, or >15, or <50 kg/mol. In embodiments, block A constitutes from 1-80, or 5-75, or 10-70, or 15-65, or 20-60, or 25-55, or 30-50, or >10, or <75 wt. %, based on total weight of the SSBC.

In embodiments, block D comprises polymerized conjugated diene monomers selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof. In embodiments, the block D has a Mₚ of 1-60, or 2-50, or 5-45, or 8-40, or 10-35, or >1.5, or <50 kg/mol. In embodiments, the block D constitutes from 10-80, or 15-75, or 20-70, or 25-65, or >10, or <75 wt. %, based on total weight of the SBC precursor.

In embodiments, block B comprises polymerized vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof. In embodiments, the block B has a mixture of the vinyl aromatic monomer and hydrogenated conjugated dienes, such as, butadiene or isoprene. In embodiments, the block B has a Mₚ of 10-300, or 20-250, or 15-60, or 10-50, or >15, or <100 kg/mol. In embodiments, the block B constitutes from 10-80, or 15-75, or 20-70, or 25-65, or 30-55, or >10, or <75 wt. %, based on total weight of the SBC precursor. In embodiments, the block B has from 0-25, or 2-20, or 5-15 wt. %, of the para-substituted styrene monomers such as those present in the block A.

In embodiments after sulfonation, block B comprises at least one sulfonic acid group, e.g., —SO₃, either in an acid form (e.g., —SO₃H, sulfonic acid) or a salt form (e.g., —SO₃Na). The sulfonate group can be in the form of metal salt, ammonium salt, or amine salt.

In embodiments, the SSBC is characterized as being sufficiently sulfonated, meaning having at least 10 mol % of sulfonic acid or sulfonate ester functional groups based on total mol of the number of monomer units or polymer blocks to be sulfonated (“degree of sulfonation”). In embodiments, the block B has a degree of sulfonation of at least 10 mol %, >15, or >20, or >25, or >30, or >40, or >50, or >60, or >70, or >80, or >90, or >99 mol %. The degree of sulfonation can be calculated by NMR or ion exchange capacity (IEC).

In embodiments, the SBC precursor is prepared by anionic polymerization using techniques known in the art. Other methods, such as cationic polymerization, can also be employed. The anionic polymerization initiator is generally an organometallic compound, such as an organolithium compound, e.g., ethyl-, propyl-, isopropyl-, n-butyl-, sec-butyl-, tert-butyl-, phenyl-, hexylbiphenyl-, hexamethylenedi-, butadieneyl-, isopreneyl-, 1,1-diphenylhexyllithium, or polystyryllithium. An amount of initiator needed is calculated based on the molecular weight to be achieved, generally from 0.002 to 5 wt. %, based on the amount of monomers to be polymerized. Suitable solvents include aliphatic, cycloaliphatic, or aromatic hydrocarbons having from 4 to 12 carbon atoms, such as pentane, hexane, heptane, cyclopentane, cyclohexane, methylcyclohexane, decalin, isooctane, benzene, alkylbenzenes, such as toluene, xylene, ethylbenzene, or mixtures thereof. Polymer chain termination can be achieved by quenching with a proton donor or a compound having a leaving group that can be displaced by the carbanionic polymer chain.

In embodiments, the SBC precursor has a general configuration of: A-D-B, A-B-D, A-D-B-D-A, A-B-D-B-A, (A-D-B)ₙA, (A-B-D)ₙA (A-D-B)ₙX, (A-B-D)ₙX, (A-D-B-D-A)ₙX, (A-B-D-B-A)ₙX or mixtures thereof; wherein n is an integer from 2 to 30; and X is a residue of a coupling agent. Each block A and D is resistant to sulfonation, and each block B is susceptible to sulfonation.

In embodiments, the coupling agent includes bi- or polyfunctional compounds, for example divinylbenzene, halides of aliphatic or araliphatic hydrocarbons, such as 1,2-dibromoethane, bis(chloromethyl)benzene, or silicon tetrachloride, dialkyl- or diarylsilicon dichloride, alkyl- or arylsilicon trichloride, tin tetrachloride, alkylsilicon methoxides, alkyl silicon ethoxides, polyfunctional aldehydes, such as terephthalic dialdehyde, ketones, esters, anhydrides, or epoxides. In embodiments, the coupling agent is selected from methyltrimethoxysilane (MTMS), methyltriethoxysilane (MTES), tetramethoxysilane (TMOS), dimethyladipate, gamma-glycidoxypropyl-trimethoxy silane, and mixtures thereof.

In embodiments, prior to hydrogenation and sulfonation, the block D has a vinyl content of >80, or >85, or >90, or >95, or >98, or >99, or >99.5, or 50-95, or 60-90, or 70-95 wt. %, based on total weight of the polymerized conjugated diene monomers in the block D.

In embodiments, the block D has a hydrogenation level of 60-99%, or 65-95%, or 70-90%, or 75-99%, or >75%, or >85%, or >95%, or >98%.

In embodiments, each block A and B independently has a hydrogenation level of 0-20%, or 2-18%, or 4-15%, or >10%, or >15%, or <20%. A suitable catalyst based on nickel, cobalt or titanium can be used in the hydrogenation step.

The SBC precursor is sulfonated to provide the corresponding SSBC. Sulfonation occurs at the phenyl ring of polymerized styrene units in the block B, predominantly para to the phenyl carbon atom bonded to the polymer backbone. In embodiments, the block B has a degree of sulfonation of 10-100, or 15-95, or 20-90, or 25-85, or 30-80, or 35-75, or 40-70, or >15, or <85 mol %, based on total mol of the block B.

In embodiments, the SSBC is a midblock-sulfonated triblock copolymer, or a midblock-sulfonated pentablock copolymer, e.g., a polyp-tert-butylstyrene-b-styrenesulfonate-b-p-tert-butyl styrene), or a poly[tert-butylstyrene-b-(ethylene-alt-propylene)-b-(styrenesulfonate)-b-(ethylene-alt-propylene)-b-tert-butylstyrene].

In embodiments, the SSBC has a Mₚ of 25-500, or 30-450, or 350-400, or 40-350, or 45-300, or 50-250, or >35, or <350 kg/mol.

In embodiments, the SSBC has a glass transition temperature (T_{g}) of 80-180° C., or 85-160° C., or 90-150° C., or 100-140° C., or >90° C., or <210° C., measured by Dynamic Mechanical Analysis (DMA), according to ASTM 4065.

In embodiments, the SSBC has an ion exchange capacity (IEC) of at least 0.5, or >0.75, or >1.0, or >1.5, or >2.0, or >2.5, or 0.5-3.5, or 0.5-2.6, or <5.0 meq/g.

In embodiments, the antifog coating layer contains the SSBC in an amount of up to 100 wt. %, or 40-99.9, or 65-99, or 90-99.9, or 85-99, or 70-95, or >50, or >60, or >80 wt. %, based on total weight of the antifog coating layer.

(Optional Additives)

In embodiments, the antifog coating layer further comprises at least one additive selected from the group consisting of initiators, cross-linking agents, activators, curing agents, stabilizers, nanoparticles, neutralizing agents, thickeners, coalescing agents, slip agents, release agents, anti-microbial agents, surfactants, antioxidants, antiozonants, color change pH indicators, plasticizers, tackifiers, film forming additives, dyes, pigments, bluing agent, UV stabilizers, UV absorbers, catalysts, fillers, other polymers, redox couples, fibers, flame retardants, viscosity modifiers, wetting agents, deaerators, toughening agents, adhesion promoters, colorants, heat stabilizers, light stabilizers, lubricants, drip retardants, anti-blocking agents, anti-static agents, processing aids, stress-relief additives, optical brightener, basic compound, and mixtures thereof.

Examples of optical brighteners include triazine-stilbene, coumarins, imidazolines, diazoles, triazoles, benzoxazolines, biphenyl stilbenes, fluorescent brightening agents, and mixtures thereof.

In embodiments, a polymer other than the SSBC include 1,2-polybutadiene, polyisoprene, polybutadiene-polyisoprene copolymers, polybutadiene-polystyrene-polydivinyl-benzene terpolymers, polyphenylene ether (PPE), curable cyclic olefins or their copolymers, polyacrylates, polydicyclopentadiene, butadiene-acrylonitrile copolymers, acrylonitrile-styrene resin, acrylonitrile-butadiene-styrene resin, polyesters, styrenic block copolymers, polyolefins, polytetrafluoroethylene (PTFB), polyetherimide (PEI), maleimide resin, cyanate ester resin, epoxy resin, phenolic resin, benzoxazine resin, polyamide resin, polyimide resin, polyphenylene sulfide, polyacetal, polysulfone, polyesterimides, polyether sulfone, polyether ketone, fluorine resin, and mixtures thereof.

In embodiments, nanoparticles are based on silica and derived from silicates, such as an alkali metal silicate or ammonium silicate. Other examples of silica include aerogel silica, silica xerogels, fumed silica, precipitated silica, and mixtures thereof. In embodiments, the surface of silica is covalently attached to hydrophilic components such as silanes, silane functionalized surfactants and acrylic silanes. An average particle size of nanoparticles can be in the range of 0.01-0.3, or 0.05-0.25, or 0.1-0.2 μm. Silica can be in the form of an elongate particle with an aspect ratio of >1.0, or >2.0, in an organic binder comprising hydrolysis products and partial condensates of one or more silane compounds, e.g., epoxy-functional silanes. Examples of other nanoparticles include ZrO₂, colloidal zirconia, Al₂O₃, colloidal alumina, CeO₂, colloidal ceria, SnO₂, colloidal tin (stannic) oxide, TiO₂, colloidal titanium dioxide, and mixtures thereof.

In embodiments, a surfactant is selected from the group consisting of non-ionic surfactants, anionic surfactants, cationic surfactants, amphoteric surfactants, and mixtures thereof. Examples of non-ionic surfactants include polyoxyethylenelauryl alcohol, polyoxyethylene lauryl ether, polyoxyethylene oleyl ether and other polyoxyethylene higher alcohol ethers, polyoxyethylene octyl phenol, polyoxyethylene nonyl phenol and other polyoxyethylene alkylaryl ethers, polyoxy ethylene glycol monostearate and other polyoxyethylene acyl esters, polypropylene glycol ethylene oxide adduct, polyoxyethylene sorbitan monolaurate, polyoxyethylene sorbitan monostearate and other polyoxyethylene sorbitan fatty acid esters, alkyl phosphate ester, polyoxyethylene alkyl ether phosphate ester and other phosphate esters, sugar esters and cellulose esters, and mixtures thereof. Examples of anionic surfactants include sodium oleate, potassium oleate and other fatty acid salts, sodium lauryl sulfate, ammonium lauryl sulfate and other higher alcohol sulfate esters, dodecylbenzene sodium sulfonate, sodium alkyl naphthalene sulfonate and other alkylbenzene sulfonic acid salts and alkyl naphthalene sulfonic acid salts, condensed formalin naphthalene sulfonate, dialkyl sulfo succinate salts, dialkyl phosphate salts, sodium polyoxyethylene alkyl phenyl ether sulfate and other polyoxyethylene sulfate salts, and mixtures thereof. Examples of cationic surfactants include ethanolamines, laurylamine acetate, triethanolamine monoformate, stearamide ethyl diethylamine acetate and other amine salts, lauryl trimethyl ammonium chloride, stearyl trimethyl ammonium chloride, dilauryl dimethyl ammonium chloride, distearyl dimethyl ammonium chloride, lauryl dimethylbenzyl ammonium chloride, stearyl dimethylbenzyl ammonium chloride and other quaternary ammonium salts, and mixtures thereof. Examples of amphoteric surfactants include dimethylalkyl lauryl betaine, dimethyl alkyl stearyl betaine and other fatty acid-based amphoteric surfactants, dimethyl alkyl sulfobetaine and other sulfonic acid-based amphoteric surfactants, and alkyl glycine, and mixtures thereof.

In embodiments, an adhesion promoter is used to enhance the adhesion of the antifog coating layer on the substrate. Examples of the adhesion promoter include mercaptosilanes; blocked mercaptosilanes; bis(trialkoxysilylorgano)polysulfides (e.g., bis(trialkoxysilylorgano) disulfides and bis(trialkoxysilylorgano)tetrasulfides); aminosilanes such as trialkoxyaminosilanes, alkyldialkoxyaminosilanes, gamma-aminopropyltrimethoxysilane, gamma-amino-propyltriethoxysilane, gamma-(aminoethyl)-aminopropyltrimethoxy-silane, methylamino-propyldimethoxysilane, methyl-gamma-(aminoethyl)-aminopropyldimethoxysilane, gamma-dimethylaminopropyltrimethoxysilane; 3-(trimethoxysilyl)propyl acrylate; 3-(acryloyloxy)propyl-triethoxysilane; methacryloxypropyltriisopropoxysilane; 3-(trimethoxysilyl)propyl methacrylatedimethylaminoethyl acrylate; diethylaminoethyl acrylate; dimethylaminopropyl acrylate; 3-dimethylamino-2,2-dimethylpropyl acrylate; 2-N-morpholinoethyl acrylate; 2-N-piperidinoethyl acrylate; N-(3-dimethylaminopropylacrylamides); N-(3-dimethylamino-2, 2-dimethyl-propyl)acrylamide; N-(4-morpholinomethyl)acrylamides; 2-(1-imidazolidin-2-on)ethyl methacrylate; vinylimidazol; vinylpyrrolidones; 3-allyl-4, 5-methoxy-2-imidazolidinones; N-(2-methacryloyloxyethyl)ethylene urea; methacrylamidoethylethylene urea; N-(2-methacryloyloxyacetamidoethyl)-N,N,N′,N′-ethylene urea; allylalkylethylene urea; N-methacrylamidomethyl urea; N-methacryoyl urea; N-[3-(1, 3-diazocyclohexan-2-on-propyl)]methacrylamide; 2-(1-imidazolyl)ethyl methacrylate; glycidoxypropyl-trimethoxysilane (GPTMS); tetramethylorthosilicate (TMOS); and mixtures thereof.

Examples of wetting agents include aliphatic alcohols, alkoxyalcohols, ethers, ether alcohols, glycol ethers, such as propylene glycol methyl ether, propylene glycol propyl ether, diprolylene glycol propyl ether, propylene glycol butyl ether, dipropylene glycol butyl ether, propylene glycol phenyl ether, ethoxylated alcohols, primary polymeric carboxylic acids, polypropylene glycol, polyethylene glycols, functionalized polyolefins, polyether-modified polysiloxane, and mixtures thereof.

Examples of UV stabilizers include hindered amine light stabilizers (HALS), benzophenones, 2-hydroxybenzophenones, salicylic acid esters, cinnamic ester derivatives, hydroxy phenyl benzotriazoles, substituted hydroxyphenyl benzotriazole, benzotriazoles, 2-hydroxybenzotriazole, substituted acrylonitrile, phenol-nickel complexes, organonickel compounds, resorcinol monobenzoates, oxanilides, hydroxybenzoic esters, triazines, cyanoacrylates, poly(ethylene naphthalates), formamidines, cinnamates, malonates, 2-2(2′-hydroxy-5′methacryloxyethylphenyl)-2H-benzotriazole available, hydroxyphenyltriazine, 2-(2′-hydroxy-5′-methylphenyl) benzotriazole, 2-(3′-tert-butyl-2′-hydroxy-5′-methylphenyl)-5-chlorobenzotriazole, 2-(3′,5′-di-tert-butyl-2′-hydroxyphenyl)-5-chlorobenzotriazole, 2-(2′-hydroxy-5′-methylphenyl)benzotriazole, 2-(2-hydroxy-5-m ethylphenyl)benzotriazole, 2-(2-hydroxy-5-tertbutylphenyl)-5-chlorobenzotriazole, 2-(2-hydroxy-3,5-di-tert-butylphenyl)benzotriazole, 2-(2-hydroxy-5-tert-butylphenyl) benzotriazole, 2-(2-hydroxy-4-octyloxyphenyl)benzotriazole, and mixtures thereof.

In embodiments, the antifog coating layer further comprises a basic compound to neutralize part of the sulfonic acid groups in the SSBC. The basic compound serves to increase the hydrophilicity of the SSBC and enhance the blushing suppression effect, while also suppressing oxidation degradation of the antifog coating layer that is caused by sulfonic acid groups in high-temperature environments, thereby improving heat resistance. Examples of basic compounds include sodium hydroxide, calcium hydroxide, ammonia, methylamine, dimethylamine, trimethylamine, ethylamine, diethylamine, triethylamine, monoethanolamine, diethanolamine, triethanolamine, dimethylaminoethanol, diethylaminoethanol, aniline, α-naphthylamine, benzylamine, pyridine, 2.6-lutidine, imidazole, and the like. A sufficient amount of the basic compound can be added to neutralize >10, or >20, or >30, or >40, or >60 mole % of the sulfonic acid or sulfonate functional groups (based on total mole of sulfonic acid or sulfonate functional groups in the SSBC).

In embodiments, the sulfonic acid or sulfonate ester functional groups in the SSBC are neutralized and crosslinked with a crosslinking agent which is any reactive compound, such as, for example, monomers, oligomers, polymers, or cationic compounds, and can have two or more functional groups selected from acrylates, vinyl, allyl, isocyanate, anhydrides, carboxylic acids, carboxylic esters, epoxies, alcohols, amines, amides, ethers, haloalkanes, thiols, ketones, esters, sulfone, and mixtures thereof. Cross-linking agents can be based on di or multivinylarene compounds; di or multiisocyanates; mono-, di-, or multianhydrides, silanes, anhydrides, and the like.

In embodiments, optional additives are added in amounts of 0-60, or 0.1-60, or 1-35, or 0.1-10, or 1-15, or 5-30 wt. %, based on total weight of the antifog coating layer.

(Optimizing Antifog Properties Using Solvent Systems)

The antifog properties of the antifog coating layer can be optimized by controlling the morphology and ordering of the layer/film formed from the SSBC. The optimization can be achieved via selection of a solvent system to dissolve the SSBC and optional additives to form the antifog coating layer with self-assembly characteristics. Further optimization of the antifog coating layer can be attained using an annealing process to obtain desired structure/morphology.

In embodiments, the antifog property of the SSBC is optimized with the selection of the solvent system which allow the incompatibility of different blocks in the SSBC to self-assemble into well-defined morphologies or nanostructures, with dimensions ranging from a few nanometers (nm) to several hundred nanometers. The morphology of the SSBC in the antifog coating layer impacts the transport properties (e.g., liquid or gas), and thus the antifog properties. The antifog coating layer containing the SSBC can have a morphology selected from the group consisting of cylindrical, lamellar, double diamond, gyroid, spheres, and mixtures thereof. Gyroids and lamellar are most preferred with the continuity in each domain leading to high transport rates. Going from a spherical to a lamellar morphology can lead to a two-fold increase in water transport.

The morphology of the SSBC in the antifog coating layer can be determined by microscopic techniques such as Scanning Electron Microscopy (SEM) and Atomic Force Microscopy (AFM) for surface morphology, and Transmission Electron Microscopy (TEM) for bulk morphology with or without one or more staining agents (e.g., osmium tetroxide(OsO₄), Ruthenium tetroxide (RuO₄), lead acetate (Pb(CH₃COO)₂·3H₂O), etc.). The morphology can also be determined by spectroscopic and scattering methods, e.g., small angle x-ray scattering (SAXS), wide angle x-ray scattering (WAXS), small angle neutron scattering (SANS), energy x-ray dispersive x-ray spectroscopy (EDS), or dynamic light scattering (DLS).

In embodiments, the solvent system is selected according to their selectivity toward the SSBC and the degree of sulfonation (IEC) of the SSBC, allowing the morphology to be tailored/fine-tuned for increased antifog performance.

In embodiment, in addition to tailoring the morphology, the solvent(s) are selected for a favorable toxicological and/or ecological profile, and desired characteristics in terms of low volatility, biodegradability, or ready biodegradability (i.e., readily biodegradable), low toxicity and/or low hazard level. Depending on the applications, the solvents are selected based on the EPA's Safer Choice Criteria for Solvents as found at https://www.epa.gov/saferchoice/standard. In embodiments, the solvent is selected from the EPA safe ingredient list at https://www.epa.gov/saferchoice/safer-ingredients#searchList, which list is incorporated herein by reference.

In embodiments, the solvent system comprises at least one hydrophilic solvent selected from the group of polyalcohols, polyalcoholalkylethers, or polyalcoholalkyletheracetates. In embodiments, the hydrophilic solvent is selected from the group consisting of ethyleneglycol monomethylether, ethyleneglycol monoethylether, ethyleneglycol monopropylether, ethyleneglycol monobutylether, ethyleneglycol monobutylether acetate, and diethyleneglycol monobutylether.

In embodiments, the solvent system is a combination of two or more solvents, e.g., two nonpolar solvents such as cyclohexane/heptane mixture, mixture of polar solvents (e.g., ethanol, methanol, or n-propanol) and nonpolar solvents such as alkanes (e.g., heptane) and aromatics (e.g., toluene).

In embodiments, the solvent system contains at least one solvent selected from the group consisting of methanol, ethanol, n-propanol, isopropanol, n-butanol, isobutanol, s-butanol, t-butanol, pentanol, hexanol, octanol, diacetone alcohol and other alcohol solvents, 3-methoxy-1-butanol, 3-methoxy-3-methyl-1-butanol, cyclopentanone, other alcohol ether solvent, acetone, methyl ethyl ketone, methyl isobutyl ketone, cyclohexanone, methyl n-propyl ketone, methyl n-isopropyl ketone, methyl n-butyl ketone, methyl isobutyl ketone, methyl n-amyl ketone, methyl isoamyl ketone, methyl n-hexyl ketone, diethyl ketone, ethyl n-butyl ketone, di n-propyl ketone, diisobutyl ketone, ethyl amyl ketone, tetrahydrofuran, dioxane, methyl acetate, ethyl acetate, n-butyl acetate, isobutyl acetate, t-butyl acetate, n-propyl acetate, methyl lactate, ethyl lactate, benzene, toluene, xylene, dimethylsulfoxide, formamide, dimethyl formamide, dimethylacetamide, N-methylpyrrolidone, petroleum ether, dimethoxyethane, nitromethane, sulfolane, acetonitrile, propionitrile, benzonitrile, hexamethylphosphoamide, aniline, pyridine, alkylaniline, dialkylaniline, dichloromethane, dichloroethane, chloroform, carbon tetrachloride, chlorobenzene, dichlorobenzene, trichlorobenzene, n-hexane, cyclohexane, methylcyclohexane, n-heptane, n-octane, n-decane, and other hydrocarbon solvents; and mixtures thereof. In embodiments, the solvent is a “green solvent” such as 2-methyltetrahydrofuran, ethyl acetate, isopropyl acetate, n-amyl acetate, isoamyl acetate, methylisoamyl acetate, methoxybutyl acetate, dihexyl acetate,-2-ethylbutyl acetate,-2-ethylhexyl acetate, cyclohexyl acetate, methylcyclohexyl acetate, isophorone, and mixtures thereof.

In embodiments, the solvent system comprises a solvent based on glycols selected from ethylene glycol, propylene glycol, ethylene glycol monomethyl ether, ethylene glycol monoethyl ether, propylene glycol monomethyl ether, propylene glycol monoethyl ether, ethylene glycol monobutyl ether (EGMBE), ethylene glycol mono hexyl ether (EGMHE), propylene glycol n-butyl ether, diethylene glycol butyl ether, ethylene glycol monoacetate, butyl carbitol, triethylene glycol monoethyl ether, 1,1′-oxybis(2-propanol), triethylene glycol monomethyl ether, triglyme, diglyme, ethylene glycol monophenyl ether, butyl carbitol, diethylene glycol monoethyl ether, dipropylene glycol monoethyl ether, triethylene glycol, dipropylene glycol monomethyl ether, dipropylene glycol monomethyl ether acetate, and mixtures thereof.

In embodiments, the solvent system is a blend of solvents selected from: a) dialkyl methylglutarate; b) a blend of: dialkyl methylglutarate, dialkyl ethylsuccinate, and optionally, dialkyl adipate; c) a blend of: dialkyl adipate, dialkyl glutarate, and dialkyl succinate; d) dioxolane; e) a blend of n-octanol and ethylene glycol monobutyl ether; f) a blend of isopropanol and ethylene glycol monobutyl ether; g) a blend of ethylene glycol monobutyl ether and n-butanol.

In embodiments, the solvent system comprises a combination of a polar solvent and a nonpolar solvent in a weight ratio of 1:10 to 10:1, or 1:8 to 8:1, or 1:5 to 5:1, or 1:2 to 2:1, or 1:1.

In embodiments, the solvent system comprises a first solvent and a second solvent different from each other, in a weight ratio of 1:10 to 10:1, or 1:8 to 8:1, or 1:5 to 5:1, or 1:2 to 2:1, or 1:1. In embodiments, the first solvent is selected from the group consisting of ethanol 1-propano, butanol, 1-pentanol, 1-undecanol, 1-decanol, decanal, 2-ethyl hexanoic acid, and mixtures thereof; and the second solvent is selected from the group consisting of ethyl acetate, tert-butyl methyl ether, 2-ethyl butyl acetate, butyl lactate, 1-decanol, toluene, isopropyl myristate, isopropyl myristate, isopropyl myristate, ethyl lactate, isododecane, n-dodecane, ethyl glycol acetate, ethylene glycol mono hexyl ether (EGMHE), neopentyl glycol, and mixtures thereof.

In embodiments, the solvent system comprises a combination of two solvents different from each other, in a weight ratio of 1:10 to 10:1, or 1:8 to 8:1, or 1:5 to 5:1, or 1:2 to 2:1, or 1:1. Examples of a pair of solvents: ethyl acetate/1-propanol, tert-butyl methyl ether/1-propanol, 2-ethyl butyl acetate/1-propanol, butyl lactate/butanol, 1-decanol/butanol, toluene/1-propanol, 1-undecanol/isopropyl myristate, 1-propanol/isopropyl myristate, decanal/isopropyl myristate, 1-undecanol/butanol, 2-ethyl butyl acetate/1-propanol, ethyl lactate/butanol, isododecane/butanol, decanal/butanol, 1-undecanol/isododecane, decanal/isododecane, n-dodecane/butanol, ethyl glycol acetate/1-propanol, ethyl glycol acetate/butanol, 1-pentanol/isopropyl myristate, 1-undecanol/1-pentanol, 2-ethyl hexanoic acid/ethyl acetate, EGMHE/1-propanol, EGMHE/butanol, EGMHE/ethyl lactate, EGMHE/ethyl glycol acetate, EGMHE/1-pentanol, EGMHE/1-decanol, EGMHE/isododecane, EGMHE/decanal, isododecane/1-pentanol, 2-ethyl hexanoic acid/EGMHE, 2-ethyl hexanoic acid/ethyl acetate, EGMHE/ethanol, isododecane/ethanol, ethyl glycol acetate/ethanol, and neopentyl glycol/ethanol.

In embodiments, the solvent system contains a single solvent, e.g., a nonpolar solvent for the antifog coating layer containing the SSBC to have a morphology with at least 50%, or >55%, or >60%, or >70%, or >80% in spherical form. The antifog coating layer is then exposed to another solvent system consisting essentially of a polar solvent, causing the spherical micelles to become interconnected. The interconnected spherical micelles (domains) in the antifog coating layer enables good moisture/water transport and enhanced antifog properties.

In embodiments, the solvent system contains a single solvent, e.g., a polar solvent, resulting in the antifog coating layer containing the SSBC to have a morphology with at least 50%, or >55%, or >60%, or >70%, or >80% lamellar morphology, and <50% cylindrical morphology.

In embodiments, the solvent system contains at least a polar and at least a nonpolar solvent (in a weight ratio, e.g., 1:3-3:1, or 1:2-2:1, or 1:1) resulting in the antifog coating layer containing the SSBC to have a morphology with at least 50%, or >55%, or >60%, or >70% lamellar morphology.

In embodiments, the solvent system when comprising a majority of nonpolar solvent (e.g., >50 wt. %) and a smaller amount of polar solvent (e.g., <50 wt. %), the morphology of the antifog coating layer containing the SSBC changes from a lamellar into a cylindrical, where block B (sulfonated block) has the cylindrical morphology while blocks A and C form bulk interconnected domains.

In embodiments, the solvent system when comprising a majority of polar solvent (e.g., >50 wt. %) and a smaller amount of nonpolar solvent (e.g., <50 wt. %), the morphology of the antifog coating layer containing the SSBC changes from a lamellar into a cylindrical, where blocks A and C have the cylindrical morphology, while block B (sulfonated block) form bulk interconnected domains.

In embodiments, the SSBC in the antifog coating layer has a morphology consisting of at least 50%, or >55%, or >60%, or >65%, or >70%, or >75%, or >80%, or >85%, or up to 100% interconnected channels.

The antifog coating layer containing SSBC and optional additives, after being combined, dissolved, dispersed, diluted, and/or added to the selected solvent(s)/solvent system. The solution/dispersant can be made into a film or applied as coating layer by methods known in the art, e.g., spraying, spin coating, brushing, dipping, flow coating, etc. The coating can be done in single stage or a multi-stage coating. In embodiments, the antifog coating layer is obtained by depositing the SSBC and optional additives in the solvent(s) on to the surface by soaking a cloth, or tissue paper, woven/non-woven object in solution/dispersant and then used for wiping the surface to obtain the antifog coating layer. The article can have one more antifog coating layers to achieve the antifog protection.

After the formation of the antifog coating layer, the antifog properties can be further tailored by an annealing step, e.g., thermal annealing and/or solvent vapor annealing, which allows for the controlling and ordering of the nanostructure/morphology in the film. Annealing can change the internal packing structure, increase the packing ordering, or a change in the ordering of the nanostructures, e.g., from spheres to lamellae, gyroids, or combinations, etc. The annealing is performed for a time sufficient to provide the internal structure organization or reorganization needed, e.g., 1-48 hrs., or >1 hr., or >4 hrs., or >12 hrs., or >24 hrs. In addition to tailoring the morphology, the pore sizes can also be tailored to have certain characteristic dimensions, e.g., varying (pore) diameter, radius, circumference, volume, depth, and the like of the SSBC nanostructures.

In embodiments, the antifog coating layer is tailored into desired morphology, e.g., lamellar and/or gyroids with a thermal annealing step, wherein the film/coating layer is thermally treated to control grain size and defect densities in the SSBC. In embodiments, the thermal annealing is conducted in a vacuum.

In a solvent annealing embodiment, the article containing the antifog coating layer is placed in contact with a selective solvent system, with a vapor that selectively mobilizes/order the nanostructures to create the desired morphologies. In embodiments, the antifog coating layer is first solvent casted followed by a subsequent solvent annealing step to further tune nanostructure in view of the self-assembly characteristics of the SSBC. The casting solvent system can be same or different than the solvent system selected for the solvent annealing step. In embodiments, the solvent annealing is conducted at room temperature.

In embodiments, instead of or in addition to solvent annealing and/or thermal annealing, the morphology optimization is conducted by spraying the antifog coating layer with a solvent system for a sufficient time to cover the layer with selected solvents, thus modifying the morphology of the finished antifog coating layer.

(Methods for Forming Antifog Coating Layer)

In embodiments, the antifog coating layer is obtained by mixing the SSBC and optional additives in a solvent system to obtain a mixture having a concentration of 5-30, or 10-25, or 10-20 wt. %, of the SSBC in the solvent system, for application in a pourable form, sprayable form, or impregnated into an applicator substrate, e.g., forming an applicator pad or wipe. In embodiments, the SSBC is in a solid form (e.g., pellet, powder, particles, flakes, etc.) or in a solution form (after polymerization in a solvent, e.g., cyclohexane, toluene, etc.) for mixing with the solvent system in the preparation of the antifog coating layer. The antifog coating layer can be obtained by coating onto surfaces or substrates by processes known in the art, e.g., dipping, flow coating, roll coating, bar coating, spray coating, curtain, rotogravure, brushing, wire wound rod coating, pan fed reverse roll coating, nip-fed coating, spraying, knife coating, spin coating, immersion coating, slot-die coating, ultrasonic spray coating, and the like. In embodiments, after the coating step to form an antifog coating layer, thermal annealing or solvent vapor annealing step follows to optimize the morphology of the SSBC. In embodiments, the antifog coating layer is first formed by solvent casting, followed by evaporation, or drying to remove a portion of the solvent, then followed by thermal annealing or solvent vapor annealing.

In embodiments, the antifog coating layer is made available on surfaces or substrates as a film, e.g., from a roll of film, or in a peel-and-stick form. The article or substrate to be coated or protected can be glass, plastic, ceramic, porcelain, and the like. The plastic substrate can be selected from polycarbonate, acrylic, styrene, polyvinylchloride, polybisallyl carbonate, polyethylene terephthalate, bi-axially oriented polypropylene (BOPP), polyethylene naphthalate, triacetate, cellulose acetate, and the like. The substrate can be substantially planar or can be configured in curved or complex shapes and can be in the form of films or sheets.

In embodiments, the surface of the substrate contains a primer layer before deposition of the antifog coating layer to further enhance the adhesion of the antifog coating layer with the surface. The primer layer can be based on acrylates, urethanes, and the like. In embodiments, the substrate further comprises an adhesive or an organic binder layer between the antifog coating layer and the surface. Commonly known adhesive layer include, e.g., pressure sensitive adhesive (PSA) based on acrylate or urethanes. For certain surfaces, the substrate can be first treated with heat, solvent, corona discharge treatment, flame treatment, plasma treatment, glow discharge treatment, surface roughening treatment, or chemical treatment to prepare the host substrate before applying the antifog coating layer.

(Properties of Antifog Coating Layer)

The antifog coating layer can be transparent or colored, and exhibit excellent antifog properties, adhesion to the substrate, heat resistance, scratch resistance, chemical resistance, water sensitivity, moisture resistance, peel resistance, delay frost formation, anti-icing, durability, and antireflective property. The Antifog coating layer on the substrate does not reduce the clarity or transparency of the substrate and has durability of several weeks, e.g., >1, or >2, or >4, or >6 weeks.

In embodiments, the SSBC has a pH of <8, or <6, or <5, or <3, or <2.5, or <2, or <1.5, or <1.25.

In embodiments, the antifog coating layer when applied on the film for food/vegetable packaging applications, has a durability of >8, or >15, or >24, or >48 hrs.

In embodiments, the antifog coating layer has a thickness of 1-100 μm, or 2-80 μm, or 5-50 μm, or >1 μm, or <40 μm.

In embodiments, the antifog coating layer has a T_{fog} of >8 sec, or >20 sec, or >25 sec, or >30 sec, or 35 sec, or >45 sec, or >1 min, measured according to ASTM F659.

In embodiments, the article containing the antifog coating layer has a yellowness index (ΔYI) of <5, or <4, or <3, or <2, or <1, measured according to ASTM E313.

In embodiments, the substrate containing the antifog coating layer, has a surface energy value of >20, or >30, or >40, or >50 dyne/cm.

In embodiments, an abrasion resistant of the antifog coating layer was measured according to ASTM D1044 (haze). Taber abrasion was measured according to ASTM D1044. The antifog coating layer containing article has a haze variation (ΔH) from haze (Hb) before the test to haze (Ha) after the test is <5%, or <4.5%, or <4%, or <3.5%, or <3%, or <2%.

In embodiments, the substrate containing the antifog coating layer has a transmittance of >80, or >85, or >88, or >90, or >92, or >94%. In embodiments, the antifog coating layer has a haze value of <3, or <2, or <1.5, or <1.25, or <1.0, or <0.75. In embodiments, the antifog coating layer has a clarity of >90, or >92, or >94, or >99, or 99.5%.

The antifog coating layer when deposited on a plastic film, e.g., PET film, can have a desirable oxygen transmission rate suitable for food, or vegetable packaging applications. In embodiments, the antifog coating layer on the plastic film has an oxygen transmission rate of 1000-20000, or 1500-18000, or 2000-15000, or 5000-12000 cc/m²/24 hrs.

The antifog coating layer can be printed with commonly known printing ink and the printing being adhered to the antifog coating layer, so that the printing will not rub off of the package.

(Applications)

The article containing the antifog coating layer can be any of automobile headlamp, automotive interior glass, windshield, auxiliary headlights, road lights, license-plate lights, tail lights, parking lights, brake lights, back-up lights, turn indicator lights, auxiliary turn indicator lights, hazard flashers, retroreflective and graphic signage, shower enclosures, underwater face masks and glasses, protective glasses, helmets, lenses for goggles, face shields, refrigerator doors, refrigerator interior parts, frost delay film or coating (e.g., freezer walls, cables, airplane wings, etc.), packaging films (e.g., food, vegetables, or products which release moisture, etc.), eyeglasses, lenses for cameras, windshields, windows for airplanes, instrument gauge for motorcycles, optical parallel plates, diving masks, microscope lenses, telescope lenses, prisms, films for use in greenhouse, mirrors (e.g., mirrors for use in dental clinics etc.), and the like.

Depending on the applications, the substrate of the article can have a thickness ranging from microns to centimeter ranges, e.g., 10 μm-5 cm, or 100 μm-10 mm, or 500 μm-2 mm. If the substrate is being used for food or vegetable packaging in the form the film, the thickness of the substrate can be in the range of 1-500 μm, or 10-400 μm, or 10-100 μm.

The antifog coating layer can be used as an anti-icing layer. The anti-icing layer on surfaces helps to remove ice, snow and/or frost (i.e., frozen precipitation) from surfaces and/or to prevent ice from forming on surfaces. The anti-icing layer is particularly useful for exterior aircraft surfaces prior to take off, or on roadway/runway surfaces. Other applications of the anti-icing layer include airport pavements, roadways, walkways, sidewalks, bridges, entrances, electrical tower structures and their components, electricity transmission lines, canals, locks, vessels, nautical components, railroad switches, motor vehicles, and the like.

### EXAMPLES

The following examples are intended to be non-limiting.

The following test methods are used.

(Antifog Test)

Antifog performance was measured according to ANSI/ISEA Z87.1 2020 (American National Standard Institute/International Safety Equipment Association) and/or ASTM F659-10.

The components used in examples include:

SSBC-1 is a solution of the sulfonated styrene-ethylene/butylene-styrene (S-SEBS) polymer in cyclohexane solvent with the concentration of 10%. The S-SEBS has the IEC of 2.0 meq/g, PSC of 35%, molecular weight (Mᵣ) of 70 kg/mol, and degree of sulfonation of 68-70%.

SSBC-1H is obtained by casting the solution of SSBC-1 and then drying to obtain the solid polymer, termed as SSBC-1H.

SSBC-1TP is obtained by dissolving SSBC-1H in toluene/propanol (50:50) solvent mixture and casting this solution followed by drying to obtain the solid polymer, termed as SSBC-1TP.

Comp-1 is a transparent polyester film of about 170 μm thickness and having antifog properties on both sides, available from 3M as 9960.

Comp-2 is a transparent polyester film of about 90 μm thickness and having antifog properties on both sides, available from 3M as 9962.

Comp-3 is a disposable full-length face shield having antifog properties, available from TIDI.

### Example 1

A dispersion/solution was prepared by adding the SSBC-1H or SSBC-1TP in a mixture of toluene/propanol (50:50) solvents to obtain a concentration of 10-15%. PET substrates were coated with the dispersion/solution by using roll coating method and dried at room temperature in a dry box with nitrogen purge for the removal of solvents. The dried PET substrates containing the antifog coating layer with varying thicknesses were used for further testing. Table 1 shows details of samples and their antifog performance.

TABLE 1

| Antifog | | | | |
|---|---|---|---|---|
| coated on | | T_{fog} (8 sec.) | | Total time |
| PET | Thickness | (ANSI/ISEA | T_{fog} (30 sec.) | to fog |
| substrate | (μm) | Z87.1) | (ASTM F659) | (in sec.) |
| SSBC-1H | 2 | Pass | Fail | 8 |
| | 5 | Pass | Fail | 17 |
| | 7 | Pass | Fail | 24 |
| SSBC-1TP | 3 | Pass | Pass | >60 |
| | 5 | Pass | Pass | >60 |
| | 7 | Pass | Pass | >60 |
| Comp-1 | — | Fail | Fail | 4 |
| Comp-2 | — | Fail | Fail | 6 |
| Comp-3 | — | Fail | Fail | 2 |

### Example 2

An experiment was conducted with 50 health care professionals wearing googles with and without a peel and stick antifog film of having a thickness of 5 microns on the lenses. Most individuals having googles without antifog film reported fogging impacting their ability to perform their tasks towards patients. Some occasionally had to touch their faces and cleaned fogged googles to continue regular work. On the other hand, most individuals having goggles with antifog film reported no or little fogging.

As used herein, the term “comprising” means including elements or steps that are identified following that term, but any such elements or steps are not exhaustive, and an embodiment can include other elements or steps. Although the terms “comprising” and “including” have been used herein to describe various aspects, the terms “consisting essentially of” and “consisting of” can be used in place of “comprising” and “including” to provide for more specific aspects of the disclosure and are also disclosed.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items.

Unless otherwise specified, all technical and scientific terms used herein have the same meanings as commonly understood by one of skill in the art to which the disclosed disclosure belongs. the recitation of a genus of elements, materials, or other components, from which an individual component or mixture of components can be selected, is intended to include all possible sub-generic combinations of the listed components and mixtures thereof.

The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims. To an extent not inconsistent herewith, all citations referred to herein are hereby incorporated by reference.

1. An article comprising: a substrate and an antifog coating layer provided on at least one surface of the substrate;
wherein the antifog coating layer comprises a sulfonated styrenic block copolymer having at least one block A, at least one block B, and at least one block D, wherein:
block A is a polymer block resistant to sulfonation and selected from polymerized: (i) para-substituted styrene monomers, (ii) ethylene, (iii) alpha olefins of 3 to 18 carbon atoms, (iv) 1,3-cyclodiene monomers, (v) monomers of conjugated dienes having a vinyl content less than 35 mole % prior to hydrogenation, (vi) acrylic esters, (vii) methacrylic esters, and (viii) mixtures thereof,
block B is a polymer block susceptible to sulfonation and derived from a vinyl aromatic monomer, wherein the block B has a degree of sulfonation of >10 mole %, and
block D is a polymer block resistant to sulfonation and derived from a conjugated diene monomer;
wherein the antifog coating layer is characterized as having:
a T_{fog} of >8 seconds, measured according to ASTM F659, and
a yellowness index (ΔYI) of <4, measured according to ASTM E313; and
wherein the sulfonated styrenic block copolymer in the antifog coating layer has a morphology consisting of at least 50% interconnected channels.

2. The article of claim 1, wherein the sulfonated styrenic block copolymer in the antifog coating layer has a morphology selected from the group consisting of cylindrical, lamellar, double diamond, gyroid, spheres, and mixtures thereof.

3. The article of claim 1, wherein the antifog coating layer is obtained by mixing the sulfonated styrenic block copolymer in a solvent system to obtain a mixture having a concentration of 5 to 30 wt. % of the sulfonated styrenic block copolymer in the solvent system and depositing the mixture on the substrate.

4. The article of claim 1, wherein the sulfonated styrenic block copolymer in the antifog coating layer has a morphology consisting of at least 50% of a lamellar morphology or a cylindrical morphology.

5. The article of claim 3, wherein the solvent system comprises a first solvent and a second solvent different from each other in a weight ratio of 1:10 to 10:1.

6. The article of claim 5, wherein
the first solvent is selected from the group consisting of ethanol 1-propano, butanol, 1-pentanol, 1-undecanol, 1-decanol, decanal, 2-ethyl hexanoic acid, and mixtures thereof; and
the second solvent is selected from the group consisting of ethyl acetate, tert-butyl methyl ether, 2-ethyl butyl acetate, butyl lactate, 1-decanol, toluene, isopropyl myristate, isopropyl myristate, isopropyl myristate, ethyl lactate, isododecane, n-dodecane, ethyl glycol acetate, ethylene glycol mono hexyl ether (EGMHE), neopentyl glycol, and mixtures thereof.

7. The article of claim 3, wherein the solvent system comprises a pair of solvents selected from ethyl acetate/1-propanol, tert-butyl methyl ether/1-propanol, 2-ethyl butyl acetate/1-propanol, butyl lactate/butanol, 1-decanol/butanol, toluene/1-propanol, 1-undecanol/isopropyl myristate, 1-propanol/isopropyl myristate, decanal/isopropyl myristate, 1-undecanol/butanol, 2-ethyl butyl acetate/1-propanol, ethyl lactate/butanol, isododecane/butanol, decanal/butanol, 1-undecanol/isododecane, decanal/isododecane, n-dodecane/butanol, ethyl glycol acetate/1-propanol, ethyl glycol acetate/butanol, 1-pentanol/isopropyl myristate, 1-undecanol/1-pentanol, 2-ethyl hexanoic acid/ethyl acetate, EGMHE/1-propanol, EGMHE/butanol, EGMHE/ethyl lactate, EGMHE/ethyl glycol acetate, EGMHE/1-pentanol, EGMHE/1-decanol, EGMHE/isododecane, EGMHE/decanal, isododecane/1-pentanol, 2-ethyl hexanoic acid/EGMHE, 2-ethyl hexanoic acid/ethyl acetate, EGMHE/ethanol, isododecane/ethanol, ethyl glycol acetate/ethanol, and neopentyl glycol/ethanol.

8. The article of claim 3, wherein when the solvent system comprises >50 wt. % of a nonpolar solvent, the block B of the sulfonated styrenic block copolymer in the antifog coating layer forms a cylindrical morphology; and wherein when the solvent system comprises >50 wt. % of a polar solvent, blocks A and C of the sulfonated styrenic block copolymer in the antifog coating layer form a cylindrical morphology.

9. The article of claim 1, wherein the antifog coating layer is further treated by performing a solvent annealing step or a thermal annealing step to tailor the morphology of the sulfonated styrenic block copolymer.

10. The article of claim 1, wherein the antifog coating layer is obtained by any of dipping, flow coating, roll coating, bar coating, spray coating, curtain, rotogravure, brushing, wire wound rod coating, pan fed reverse roll coating, nip-fed coating, knife coating, spin coating, immersion coating, slot-die coating, or ultrasonic spray coating.

11. The article of claim 1, wherein the antifog coating layer comprises 65-99 wt. % of the sulfonated styrenic block copolymer and 1-35 wt. % of at least an additive, based on total weight of the antifog coating layer.

12. The article of claim 11, wherein the at least an additive is selected from the group consisting of initiators, cross-linking agents, activators, curing agents, stabilizers, nanoparticles, neutralizing agents, thickeners, coalescing agents, slip agents, anti-microbial agents, surfactants, antioxidants, antiozonants, color change pH indicators, plasticizers, tackifiers, film forming additives, dyes, pigments, bluing agent, UV stabilizers, UV absorbers, catalysts, fillers, other polymers, flame retardants, viscosity modifiers, wetting agents, deaerators, toughening agents, adhesion promoters, colorants, lubricants, drip retardants, anti-blocking agents, anti-static agents, processing aids, stress-relief additives, optical brightener, basic compound, and mixtures thereof.

13. The article of claim 1, wherein the antifog coating layer has a thickness of 1 to 100 μm; and wherein the substrate is selected from glass, ceramic, porcelain, polycarbonate, acrylic polymer, polystyrene, polyvinylchloride, polybisallyl carbonate, polyethylene terephthalate, bi-axially oriented polypropylene (BOPP), polyethylene naphthalate, and cellulose acetate.

14. The article of claim 1, wherein the antifog coating layer has a T_{fog} of >20 sec.

15. The article of claim 1, wherein the antifog coating layer has a surface energy value of >20 dyne/cm.

16. The article of claim 1, wherein the antifog coating layer has at least one of:
a transmittance of >80%;
a haze value of <3; and
a clarity of >90%.

17. The article of claim 1, wherein
each block A comprises the polymerized para-substituted styrene monomers selected from the group consisting of para-methylstyrene, para-ethylstyrene, para-n-propylstyrene, para-iso-propylstyrene, para-n-butylstyrene, para-sec-butylstyrene, para-iso-butylstyrene, para-t-butylstyrene, isomers of para-decylstyrene, isomers of para-dodecylstyrene, and mixtures thereof;
each block B comprises the polymerized vinyl aromatic monomers selected from the group consisting of unsubstituted styrene, ortho-substituted styrene, meta-substituted styrene, alpha-methylstyrene, 1,1-diphenylethylene, 1,2-diphenylethylene, and mixtures thereof; and
each block D comprises the polymerized conjugated diene monomer selected from the group consisting of isoprene, 1,3-butadiene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, and mixtures thereof.

18. The article of claim 1, wherein the sulfonated styrenic block copolymer is obtained by sulfonation of a styrenic block copolymer precursor having a general configuration of: A-D-B, A-B-D, A-D-B-D-A, A-B-D-B-A, (A-D-B)ₙA, (A-B-D)ₙA (A-D-B)ₙX, (A-B-D)ₙX, (A-D-B-D-A)ₙX, (A-B-D-B-A)ₙX, or mixtures thereof; wherein n is an integer from 2 to 30; and X is a residue of a coupling agent.

19. The article of claim 1, wherein the block B has a degree of sulfonation of 10 to 100 mol %, based on total mol of the block B.

20. The article of claim 1, wherein the sulfonated styrenic block copolymer has an ion exchange capacity of 0.5 to 2.6 meq/g.
